(19) United States
(12) Patent Application Publication
(10) Pub. No.: US 2025/0210771 A1
(43) Pub. Date: Jun. 26, 2025

(54) BATTERY PACK

(71) Applicant: TOYOTA JIDOSHA KABUSHIKI KAISHA, Toyota-shi (JP)

(72) Inventors: Tatsuma YAHARA, Seto-shi (JP); Kensuke MATSUO, Seto-shi (JP); Shigeyuki INOUE, Toyota-shi (JP)

(73) Assignee: TOYOTA JIDOSHA KABUSHIKI KAISHA, Toyota-shi (JP)

(21) Appl. No.: 18/905,515

(22) Filed: Oct. 3, 2024

(30) Foreign Application Priority Data
Dec. 26, 2023 (JP) 2023-219397

(51) Int. Cl. H01M 50/238; H01M 50/204; H01M 50/22

(52) U.S. Cl. CPC H01M 50/238; H01M 50/22; H01M 50/204

(57) ABSTRACT

A battery pack that houses a battery stack including a plurality of stacked battery cells includes a lower case and an upper case. The upper case includes a bottom wall portion and a side wall portion. The end portion or side wall portion of the bottom wall portion includes an extra length portion. The extra length portion is extended and configured to displace an end portion of the bottom wall portion, which is near a connecting portion between the bottom wall portion and the side wall portion, upward by the gas generated in the battery pack.

### CROSS-REFERENCE TO RELATED APPLICATION

This application claims priority to Japanese Patent Application No. 2023-219397 filed on Dec. 26, 2023, incorporated herein by reference in its entirety.

### BACKGROUND

### 1. Technical Field

The present disclosure relates to a battery pack.

### 2. Description of Related Art

An electrified vehicle such as a battery electric vehicle, a hybrid electric vehicle, or the like, is equipped with a battery pack.

WO 2023/181751 discloses a battery pack including a pressure release portion in a portion of an upper case that has higher rigidity than other portions.

### SUMMARY

There is demand for reduction in the size of the battery pack, in order to improve installation efficiency. Accordingly, excess space between the upper case and the battery pack is also limited. Hot gas and debris discharged from cells of the battery pack are locally diffused to a certain region in the excess space, and the upper case is locally lifted. This may cause short-circuiting among the high voltage components over the upper case that is locally lifted.

A battery pack according to an aspect of the present disclosure accommodates a battery stack including a plurality of battery cells that is stacked,
the battery pack including a lower case, and an upper case, in which
the upper case includes a bottom wall portion and a side wall portion, and
an end portion or the side wall portion of the bottom wall portion includes an extra length portion.

In the above battery pack, the extra length portion may be configured to be extended or slid by gas generated from the battery pack to displace the end portion of the bottom wall portion upward, the end portion of the bottom wall portion being a connecting portion between the bottom wall portion and the side wall portion.

In the above battery pack, the extra length portion may include at least one of portions in an S-shape, a U-shape, a V-shape, and a W-shape.

In the above battery pack, the extra length portion may include a first portion joined to the side wall portion, the first portion being made of a material with a higher elongation than an elongation of the material of the side wall portion, or the first portion being made with a smaller plate thickness than a plate thickness of the side wall portion.

In the above battery pack, the extra length portion may include a first side wall portion connected to the bottom wall portion, and a second side wall portion separate from the bottom wall portion, the first side wall portion and the second side wall portion may be configured to be slidable, and a seal portion may be provided between the first side wall portion and the second side wall portion.

According to the present disclosure, a battery pack can be provided that is configured to displace the end portion of the bottom wall portion of the upper case upward, with respect to a middle portion of the bottom wall portion of the upper case, by gas or the like generated in the battery pack.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view illustrating a vehicle underbody and a battery pack according to some embodiments of the present disclosure;

FIG. 2 is a cross-sectional view illustrating an exemplary extra length portion of the upper case shown in the circular VI of FIG. 1 according to some embodiments of the present disclosure;

FIG. 3 is a diagram illustrating various modifications of an extra length portion of a bottom wall portion of an upper case according to some embodiments of the present disclosure;

FIG. 4 is a cross-sectional view illustrating various other modifications of the extra length portion of the side wall portion of the upper case according to some embodiments of the present disclosure;

FIG. 5 is a cross-sectional view illustrating various other modifications of the extra length portion of the upper case according to some embodiments of the present disclosure; and

FIG. 6 is a cross-sectional view for explaining an effect of the presence or absence of an extra length portion of the upper case at the time of smoking.

### DETAILED DESCRIPTION OF EMBODIMENTS

Hereinafter, specific embodiments to which the present disclosure is applied will be described in detail with reference to the drawings. However, the present disclosure is not limited to the following embodiments. Further, for clarity of explanation, the following description and the drawings are simplified as appropriate.

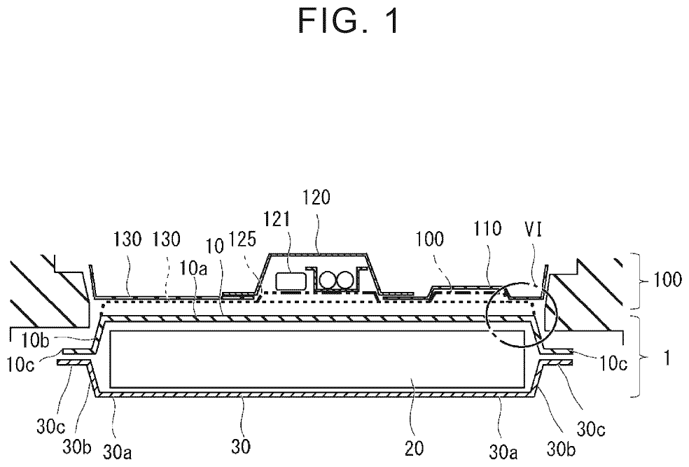

FIG. 1 is a cross-sectional view illustrating an underbody 100 and a battery pack 1 for a vehicle according to some embodiments of the present disclosure. The battery pack 1 is disposed under the underbody 100 constituting the lower surface of the vehicle body. The battery pack 1 houses a battery stack 20 including a plurality of stacked battery cells. The battery pack 1 includes a battery stack 20, a lower case 30, and an upper case 10. The battery stack 20 is covered with a lower case 30 and an upper case 10. The battery stack 20 includes a plurality of stacked battery cells. The battery cell is, for example, a secondary battery such as a nickel metal hydride battery or a lithium-ion battery. The battery cell may include an inorganic solid electrolyte.

The lower case 30 has a box shape having an opening at an upper portion thereof, and has a bottom wall portion 30a, a side wall portion 30b, and a flange portion 30c. The upper case 10 has a box shape having an opening at an upper portion thereof, and has a bottom wall portion 10a, a side wall portion 10b, and a flange portion 10c. The flange portion 30c of the lower case 30 and the flange portion 10c of the upper case 10 are coupled to each other by fastening the mating surfaces with a plurality of bolts or the like along the circumferential direction with a sealing member such as a packing sandwiched therebetween.

The underbody 100 includes a floor bead portion 110 protruding upward, and a floor tunnel portion 120 extending to the front and rear of the vehicle at the center of the vehicle width. A high-voltage component 121, a cable, or the like is disposed inside the floor tunnel portion 120. That is, the high-voltage component 121 and the like are disposed on the central part of the bottom wall portion 10a of the upper case 10 of the battery pack 1.

The upper case 10 has an extra length portion (to be described later) which is one of the features of the present disclosure at both end portions or the side wall portion 10b of the bottom wall portion 10a. The extra length portion is formed by bending in various forms, and is configured to be stretched or slid by the gas generated from the battery pack. Examples of the shape of the extra length portion may be S-shaped, U-shaped, V-shaped, and W-shaped, and combinations thereof. In the present specification, the end portion of the bottom wall portion 10a of the upper case 10 may refer to both side portions (that is, excluding the central portion) when the bottom wall portion 10a is divided into three equal portions from the connecting portion between the bottom wall portion 10a and the side wall portion 10b. More preferably, the end portion of the bottom wall portion of the upper case 10 may refer to both side portions (excluding the central portion) when the bottom wall portion is divided into five equal portions from the connecting portion between the bottom wall portion and the side wall portion. As shown in the circular VI of FIG. 1, the extra length portion of the right end portion will be described in detail.

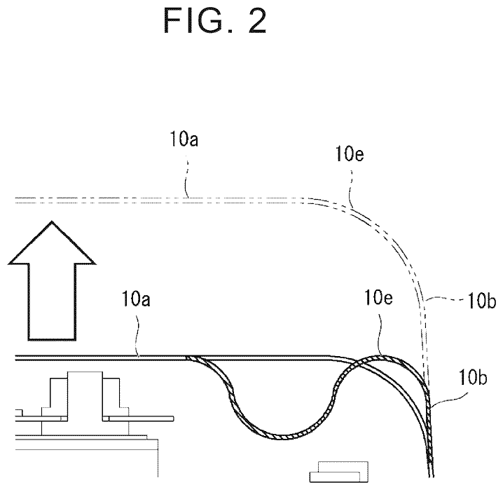

FIG. 2 is a cross-sectional view illustrating an exemplary extra length portion of the upper case illustrated in the circular VI of FIG. 1.

The extra length portion 10e of the upper case 10 is bent in an S-shape at the right end portion of the bottom wall portion 10a when viewed from the paper surface direction (vehicle front-rear direction). The bottom wall portion 10a of the upper case 10 is raised upward by the gases generated from the battery pack inside the upper case 10, and the extra length portion 10e is extended. The upper case is configured to displace an end portion of the bottom wall portion upward with respect to a central portion of the bottom wall portion 10a. As a result, the bottom wall portion 10a of the upper case 10 is raised substantially horizontally not only at the center portion but also at the end portion of the bottom wall portion. Therefore, even if the surplus space between the upper case and the battery pack is also limited, the gas and the like generated from the battery pack can diffuse over the entire surplus space, and as a result, a short circuit between the high-voltage components can be prevented.

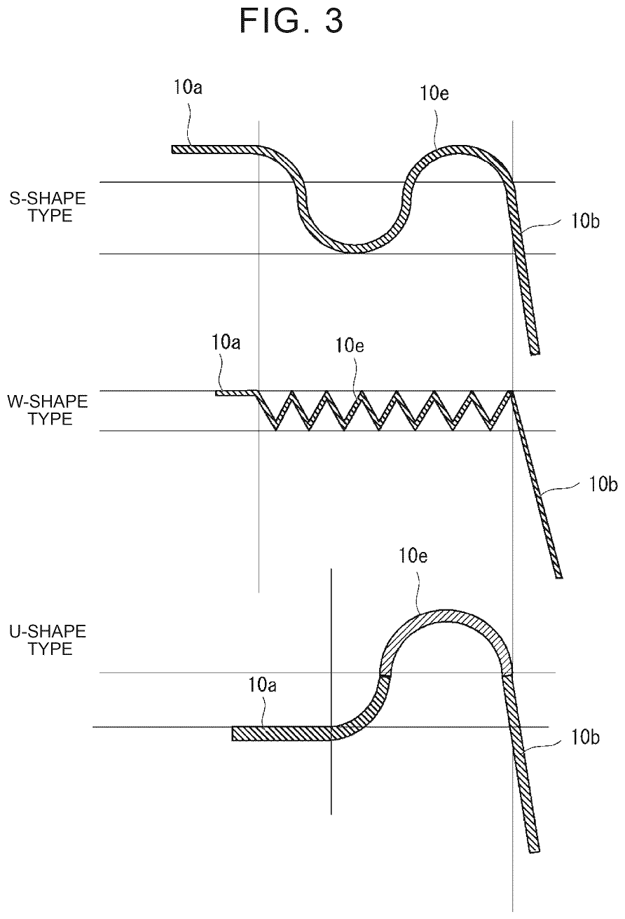

FIG. 3 is a view for explaining various modifications of the extra length portion of the bottom wall portion of the upper case.

The modification shown in FIG. 3 shows various extra-lengths formed at the right end portion of the bottom wall portion 10a of the upper case 10. In the upper view of FIG. 3, the extra length portion 10e of the upper case 10 is bent in an S-shape when viewed from the paper surface direction (vehicle front-rear direction) at the right end portion of the bottom wall portion 10a of the upper case 10. The S-shaped number is not limited to this.

In the drawing of FIG. 3, the extra length portion 10e of the upper case 10 is bent in a W-shape or a V-shape at the right end portion of the bottom wall portion 10a when viewed from the paper surface direction (vehicle front-rear direction). Note that the number of the W-shape or the V-shape is not limited to this.

In the lower view of FIG. 3, the extra length portion 10e of the upper case 10 is bent in a U-shape at the right end portion of the bottom wall portion 10a when viewed from the paper surface direction (vehicle front-rear direction). The number of U-shaped portions is not limited to this.

The upper case 10 of these modifications may be configured to displace the end portion of the bottom wall portion 10a upward with respect to the central portion of the bottom wall portion 10a by extending the extra length portion 10e of the end portion of the bottom wall portion 10a by the gases generated from the battery cells or the like. Therefore, the bottom wall portion 10a of the upper case 10 rises substantially horizontally not only at the center portion but also at the end portion.

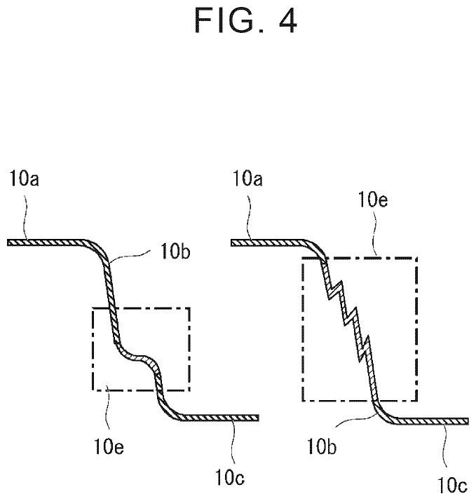

FIG. 4 is a cross-sectional view illustrating various other modifications of the extra length portion of the side wall portion of the upper case.

The left-hand view of FIG. 4 shows a smoothly bent extra length portion 10e formed in the side wall portion 10b. The number of smoothly bent portions is not limited thereto. The right-hand side view of FIG. 4 shows a jagged, stepwise bent extra length portion 10e formed in the side wall portion 10b. The number of jagged stepwise bent portions is not limited thereto.

The upper case 10 of these modifications may be configured such that the extra length portion 10e of the side wall portion is extended by the gases generated from the battery cells or the like, and the end portion of the bottom wall portion 10a is displaced upward with respect to the central portion of the bottom wall portion 10a. Therefore, the bottom wall portion 10a of the upper case 10 rises substantially horizontally not only at the center portion but also at the end portion.

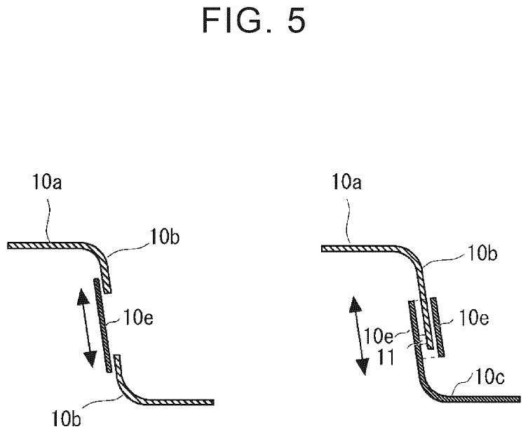

FIG. 5 is a cross-sectional view for explaining various other modifications of the extra length portion of the side wall portion of the upper case.

The left-hand side view of FIG. 5 shows a first portion (extra length portion 10e) joined to the side wall portion 10b. The first part includes a material having a higher stretch ratio than the stretch ratio of the material on the side wall portion 10b. Alternatively, in another modification, the first portion (the extra length portion 10e) is thinner than the plate thickness of the side wall portion 10b. As a result, the first portion is locally stretched by the gas or the like generated from the battery pack in the upper case.

The right side view of FIG. 5 also includes the first side wall portion 10b connected to the bottom wall portion 10a and a second side wall portion (an extra length portion 10e) separate from the bottom wall portion 10a. The second side wall portion (the extra length portion 10e) has a cylindrical configuration in which the first side wall portion 10b connected to the bottom wall portion 10a is slidably inserted through the seal portion. The seal portion may be a seal sponge, a rubber gasket, or the like. In FIG. 5, a cylindrical structure is provided on the second side wall portion (the extra length portion 10e), but a cylindrical structure may be provided on the first side wall portion 10b.

The upper case 10 of these modifications may be configured such that the extra length portion 10e of the side wall portion is extended or slid due to gases generated from the battery cells or the like, and the end portion of the bottom wall portion 10a is displaced upward with respect to the central portion of the bottom wall portion 10a. Therefore, the bottom wall portion 10a of the upper case 10 rises substantially horizontally not only at the center portion but also at the end portion.

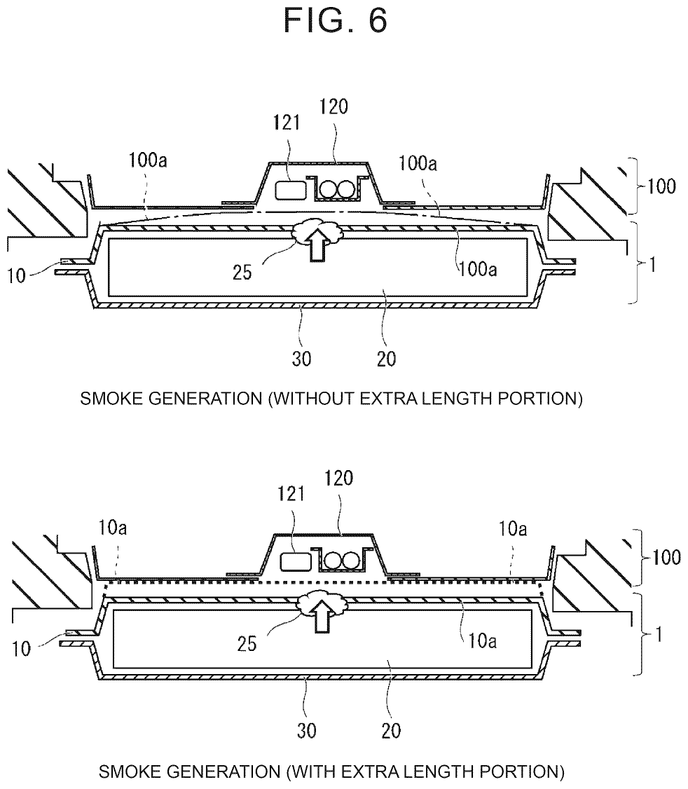

FIG. 6 is a cross-sectional view for explaining an effect of the presence or absence of an extra length portion of the upper case at the time of smoking. When gases 25 and debris are generated from the battery stack 20, the bottom wall portion 100a (without the extra length portion) of the upper case 10 is lifted upward. The upper view of FIG. 6 shows a case where there is no extra length portion in the upper case. The central portion of the bottom wall portion 100a of the upper case 10 is raised above the end portion of the bottom wall portion 10a and reaches the floor tunnel portion 120 above the central portion. As a result, there is a possibility that a high-voltage component or the like inside the floor tunnel portion 120 is short-circuited.

The bottom view of FIG. 6 shows a case where there is an extra length portion in the upper case. When the gas 25 or the debris is generated from the battery stack 20, the bottom wall portion 10a (with an extra length portion) of the upper case 10 displaces the end portion of the bottom wall portion 10a upward with respect to the center portion of the bottom wall portion 10a. Therefore, the bottom wall portion 10a of the upper case 10 rises substantially horizontally not only at the center portion but also at the end portion. As a result, even if the excess space between the upper case and the battery pack is also limited, gas or the like generated from the battery pack can diffuse over the entire excess space, and consequently, a short circuit between the high-voltage components can be prevented.

The present disclosure is not limited to the above-described embodiments, and can be appropriately modified without departing from the spirit.

What is claimed is:

1. A battery pack that accommodates a battery stack including a plurality of battery cells that is stacked, the battery pack comprising:
a lower case; and
an upper case, wherein:
the upper case includes a bottom wall portion and a side wall portion; and
an end portion or the side wall portion of the bottom wall portion includes an extra length portion.

2. The battery pack according to claim 1, wherein the extra length portion is configured to be extended or slid by gas generated from the battery pack to displace the end portion of the bottom wall portion upward, the end portion of the bottom wall portion being a connecting portion between the bottom wall portion and the side wall portion.

3. The battery pack according to claim 1, wherein the extra length portion includes at least one of portions in an S-shape, a U-shape, a V-shape, and a W-shape.

4. The battery pack according to claim 1, wherein the extra length portion includes a first portion joined to the side wall portion, the first portion being made of a material with a higher elongation than an elongation of a material of the side wall portion, or the first portion being made with a smaller plate thickness than a plate thickness of the side wall portion.

5. The battery pack according to claim 1, wherein:
the extra length portion includes a first side wall portion connected to the bottom wall portion, and a second side wall portion separate from the bottom wall portion;
the first side wall portion and the second side wall portion are configured to be slidable; and
a seal portion is provided between the first side wall portion and the second side wall portion.
